(19) United States
(12) Patent Application Publication
(10) Pub. No.: US 2004/0056919 A1
(43) Pub. Date: Mar. 25, 2004

(54) Printer method and apparatus

(75) Inventors: Gonzalo Gaston, Barcelona (ES); Antoni Monclus, Barcelona (ES); Carles Flotats, Barcelona (ES); Isabel Borrell, Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/643,940

(22) Filed: Aug. 20, 2003

(30) Foreign Application Priority Data
Aug. 30, 2002 (GB) 0220110.1

(51) Int. Cl. B41J 2/165

(52) U.S. Cl. 347/22

(57) ABSTRACT

An inkjet printing device comprising a plurality of printheads and a plurality of servicing modules, each module comprising first and second sets of servicing components and being arranged to service exclusively a given printhead, said first set comprising a spittoon and said first or said second set being independently replaceable.

### TECHNICAL FIELD

The present invention relates generally to printing devices and more particularly, although not exclusively to, methods and apparatus for servicing inkjet cartridges or pens.

### BACKGROUND ART

Inkjet printing mechanisms often use cartridges, which eject drops of liquid dye or colorants, generally referred to as “ink,” onto paper or some other media. Each cartridge includes a printhead with one or more nozzles. The ink is fired through these nozzles as the printhead is scanned across a sheet of media so that the ink may be dispersed in a desired pattern to thereby record information on the media.

In order to increase the useful lives of the printheads, as well as their performance, a service station is typically provided, generally adjacent to the printing area within the printing mechanism to perform servicing operations on the printheads. When a servicing operation is required, for example, determined according to a selected print mode, the printheads may be maneuvered to a location near the service station. Depending upon the particular arrangement, the printheads may be above, below, or alongside the service station during the servicing operation.

Service stations are typically equipped with a plurality of modules configured to perform the servicing operations on the printheads. In order to avoid cross-contamination between the different inks of different printheads, a separate servicing module is provided for each printhead. The modules are typically supported within bays provided on a carriage of the service station.

Generally speaking, each module is arranged to carry out a number of operations on its associated printhead. To carry out this function, each module typically comprises a wiper, a cap and a spittoon. The wiper is configured to wipe the printhead in an effort to remove ink residue, as well as any dust and other debris that may have accumulated on the printhead. The cap is designed to substantially seal the printhead nozzles from contaminants and from drying during storage, or even simply during non-printing periods. The spittoon generally acts as a receptacle to capture spitted ink, a process that may be implemented to clear out, or unblock the nozzles of the printhead. During a typical printing operation, one or more of the above operations may be performed on the printhead.

Advances in printer technology have made it possible for the use of relatively small nozzles and quick-drying ink. Although print quality has been improved, this has also led to increasing difficulty in maintaining the health of the printheads and the nozzles contained thereon. For example, one problem known to occur with these advanced printheads is that their nozzles may become clogged at a relatively faster rate than was experienced with previously known printheads. At the same time, today's printheads may have a relatively longer useful life than their predecessors. Because of this, there is again a greater probability that such printheads may become clogged or otherwise damaged. As a consequence, it would be desirable to provide an Improved service arrangement to service such printheads.

### SUMMARY OF THE INVENTION

According to one aspect of the invention, there is provided an inkjet printing device comprising a plurality of printheads and a plurality of servicing modules, each module comprising first and second sets of servicing components and being arranged to service exclusively a given printhead, said first set comprising a spittoon and said first or said second set being independently replaceable.

Advantageously, by allowing a first set of servicing components to be renewed without having also to renew a second set of servicing components, servicing costs may be reduced and more flexible servicing routines may be implemented.

Advantageously, the present invention makes it possible, in a cost effective manner, to replace given servicing components together with the replacement of relevant hardware. Thus, allowing users to use cost effective servicing kits to ensure consistently high print quality though correct, cost effective servicing.

Preferably, selected servicing components may be individually replaced. Such individual servicing components may include, amongst others: a spittoon; a wiper; or, a cap.

Alternatively, selected combinations of servicing components may be individually replaced. Such combination may be formed either as an integral unit or as separate components. This may include, for example, any two of: a spittoon; a wiper; and, a cap.

The present invention also extends to the corresponding methods. Furthermore, the present invention also extends to a kit of servicing components.

Other aspects and advantages of the present invention will be apparent from the following detailed description, together with the accompanying drawings.

### BRIEF DESCRIPTION OF THE DRAWINGS

Features and aspects of the present invention will become apparent to those skilled in the art from the following description with reference to the drawings, in which:

FIG. 1 illustrates an embodiment of a printer system in accordance with an embodiment of the present invention;

FIG. 2 illustrates an embodiment of the service station carriage of the printer system of FIG. 1; and,

FIG. 3 illustrates a servicing module suitable for use with a printer system such as that shown in FIG. 1.

### DETAILED DESCRIPTION OF PREFERRED EMBODIMENTS

Before explaining the disclosed embodiments of the present invention in detail, it is to be understood that the invention is not limited in its application to the details of any particular arrangement shown, since the invention is capable of other embodiments. The terminology used herein is for the purpose of description and not of limitation.

There will now be described by way of example only the best modes contemplated by the inventors for carrying out the invention.

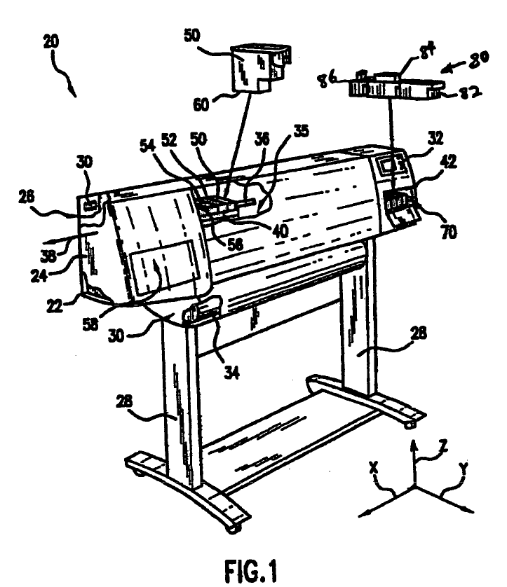

FIG. 1 illustrates an embodiment of a printer 20 constructed in accordance with an embodiment of the present invention, which may be used for recording information onto a recording medium, such as, paper, textiles, and the like, in an industrial, office, home or other environment. The present invention may be practiced in a variety of printers. For instance, it is contemplated that an embodiment of the present invention may be practiced in textile printers, desk top printers, portable printing units, copiers, and facsimile machines, to name a few. For convenience, the concepts of the present invention are illustrated in the environment of a large format printer 20.

While it is apparent that the printer components may vary from model to model, the printer 20 includes a chassis 22 surrounded by a housing or casing enclosure 24, typically of a plastic material, together forming a print assembly portion 26 of the printer 20. While it is apparent that the print assembly portion 26 may be supported by a desk or tabletop, it is preferred to support the print assembly portion 26 with a pair of leg assemblies 28. The printer 20 also has a printer controller 30, illustrated schematically as a microprocessor, that receives instructions from a host device, typically a computer, such as a personal computer or a computer aided drafting (CAD) computer system (not shown). A manner in which the controller 30 operates will be described in greater detail herein below.

The printer controller 30 may also operate in response to user inputs provided through a key pad and status display portion 32, located on the exterior of the casing 24. A monitor coupled to the host device may also be used to display visual information to an operator, such as the printer status or a particular program being run on the host device. Personal and drafting computers, their input devices, such as a keyboard and/or a mouse device, and monitors are all well known to those skilled in the art.

A conventional recording media handling system (not shown) may be used to advance a continuous sheet of recording media 34 from a roll through a printzone 35. The recording media may be any type of suitable sheet material, such as paper, poster board, fabric, transparencies, mylar, and the like. A carriage guide rod 36 is mounted to the chassis 22 to define a scanning axis 38, with the guide rod 36 slideably supporting a carriage 40 for travel back and forth, reciprocally, across the printzone 35. A conventional carriage drive motor (not shown) may be used to propel the carriage 40 in response to a control signal received from the controller 30. To provide carriage positional feedback information to controller 30, a conventional metallic encoder strip (not shown) may extend along the length of the printzone 35 and over a servicing region 42.

A conventional optical encoder reader may be mounted on the back surface of carriage 40 to read positional information provided by the encoder strip, for example, as described in U.S. Pat. No. 5,276,970, also assigned to Hewlett-Packard Company, the assignee of the present invention. The manner of providing positional feedback information via the encoder strip reader, may also be accomplished in a variety of ways known or heretofore known to those skilled in the art.

Upon completion of printing an image, the carriage 40 may be used to drag a cutting mechanism across the final trailing portion of the media to sever the image from the remainder of the roll 34. Suitable cutter mechanisms are commercially available in DesignJet. RTM. 650C and 750C color printers. Of course, sheet severing may be accomplished in a variety of other ways known to those skilled in the art. Moreover, the illustrated printer 20 may also be used for printing images on pre-cut sheets, rather than on media supplied in a roll 34.

In the printzone 35, the recording medium receives ink from four cartridges 50, 52, 54 and 56. Although four cartridges are illustrated, it is within the purview of the present invention that the printer may contain any reasonably suitable number of cartridges, e.g., two, six, seven, eight, and the like. For purposes of simplicity and illustration, printer 20 will be described in terms of the four cartridges. Thus, the addition of further cartridges may be implemented in the same or like manner as described herein below with respect to cartridges 50, 52, 54 and 56.

Print cartridges are also often called “pens” by those in the art. One of the pens, for example pen 50, may be configured to eject black ink onto the recording medium, where the black ink may contain a pigment-based ink. Pens 52, 54 and 56 may be configured to eject variously colored inks, e.g., yellow, magenta, cyan, light cyan, light magenta, blue, green red, to name a few. In the present embodiment, the pens 52, 54 and 56 each contain a dye-based ink of the colors yellow, magenta and cyan, respectively. It is apparent that the color pens may also contain pigment-based inks in some implementations. It is apparent that other types of inks may also be used in the pens, such as paraffin-based inks, as well as hybrid or composite inks having both dye and pigment characteristics.

The printer 20 uses an “off-axis” ink delivery system, having main stationary reservoirs (not shown) for each ink (black, cyan, magenta, yellow) located in an ink supply region 58. In this respect, the term “off-axis” generally refers to a configuration where the ink supply is separated from the printheads. In this off-axis system, the pens may be replenished by ink conveyed through a series of flexible tubes (not shown) from the main stationary reservoirs so only a small ink supply is propelled by carriage 40 across the printzone 35 which is located “off-axis” from the path of printhead travel. Some or all of the main stationery reservoirs may be located in a region generally away from the interior of the printer 20. In addition, the number of main stationary reservoirs may vary and is not required to equal the number of pens utilized in the printer 20. In this respect, the printer 20 may include a lesser or greater number of reservoirs than the number of pens. As used herein, the term “pen” or “cartridge” may also refer to a replaceable printhead cartridge where each pen has a reservoir that carries the entire ink supply as the printhead reciprocates over the printzone.

The illustrated pens each have a respective printhead (of which only printhead 60 is shown). The printheads selectively eject ink to form an image on a sheet of media 34 in the printzone 35. These printheads have a large print swath, for instance about 20 to 25 millimeters (about one inch) wide or wider, although the concepts described herein may also be applied to smaller or larger printheads. The printheads each have an orifice plate with a plurality of nozzles formed there through in a manner well known to those skilled in the art.

The nozzles of each printhead, e.g., printhead 66, are typically formed in at least one, but typically two linear arrays along the orifice plate. Thus, the term “linear” as used herein may be interpreted as “nearly linear” or substantially linear, and may include nozzle arrangements slightly offset from one another, for example, in a zigzag arrangement. Each linear array is typically aligned in a longitudinal direction substantially perpendicular to the scanning axis 38, with the length of each array determining the maximum image swath for a single pass of the printhead. The printheads of the present embodiment are thermal inkjet printheads, although other types of printheads may be used, such as piezoelectric printheads. The thermal printheads typically include a plurality of resistors which are associated with the nozzles. Upon energizing a selected resistor, a bubble of gas is formed which ejects a droplet of ink from the nozzle and onto a sheet of print medium in the printzone 35 under the nozzle. The printhead resistors are selectively energized in response to firing command signals delivered from the controller 30 to the printhead carriage 40.

The printer 20 is illustrated as including a printhead service station 70. The service station 70 may be provided within the printer 20 along the scan axis of the carriage 40 to enable the printheads to be positioned adjacent to the service station 70. In this position, the service station 70 may perform servicing operations on the printheads, e.g., wiping, capping, receiving spitted ink, etc. As illustrated in FIG. 1, the service station 70 includes a plurality of servicing modules. More specifically, there are four servicing modules 80 located within the service station 70. An enlarged view of one of the servicing modules 80 is illustrated in FIG. 1. According to the present embodiment, each of the servicing modules 80 is designed to perform servicing operations exclusively on a respective printhead. In this respect, for example, each of the printheads may be serviced without substantial cross-contamination from the other printheads.

According to the present embodiment of the invention, each servicing module 80 is composed of a plurality of components 82, 84 and 86. In the present example these include, a spittoon component 82, a cap component 84 and a wiper component 86.

As will be described in greater detail herein below, each of the components 82, 84 and 86 for each module is a separate component that may be individually removed from the service station 70 without requiring substantial manipulation of the other components of the same module or indeed the other modules of the service station.

Although the spittoon component 82 is illustrated as being located forward of the cap component 84, which in turn is located forwardly of the wiper component 86, it should be understood that these components may be configured in any reasonably suitable configuration. For example, the wiper component 86 may be positioned forwardly of the cap component 84 and the spittoon component 86.

In other embodiments, the configuration of the components 82, 84 and 86 may be selected in accordance with operational requirements and the structure of the printer device in question. In addition, although the spittoon component 82, cap component 84 and the wiper component 86 are aligned in the Y-axis direction in FIG. 1, this need not be the case in further embodiments. For example, the spittoon component 82, cap component 84 and the wiper component 86 may be aligned along the scan axis of the carriage 40 without departing from the scope of the invention.

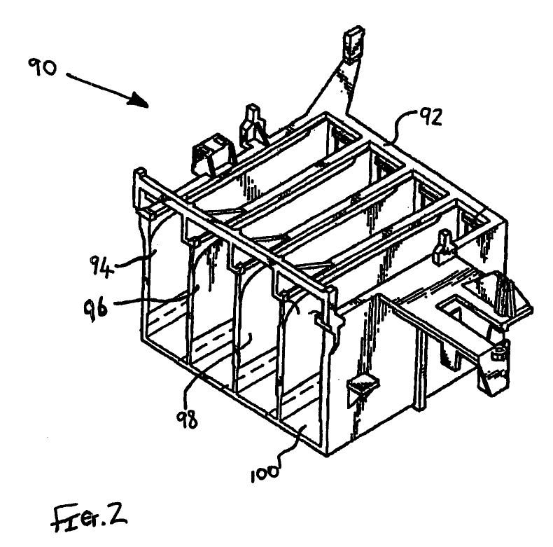

The service station 70 includes a service station carriage 90. FIG. 2 illustrates the service station carriage 90 of the present embodiment of the invention. As is shown in FIG. 2, the service station carriage 90 includes a housing 92 having a plurality of bays 94, 96, 98 and 100 for supporting respective servicing modules 80. The service station carriage 90 may be translationally moveable, and may be selectively driven by a motor through a rack and pinion gear assembly (not shown) in response to a drive signal received from the controller 30. Therefore, each component of a given module 82, 84 and 86 may be positioned relative to its respective printhead to thereby enable performance of selected servicing operations on the printhead. For example, the service station carriage 90 may be translated in a forward direction to effectuate a wiping operation on the printheads and in a rearward direction to perform a spitting operation.

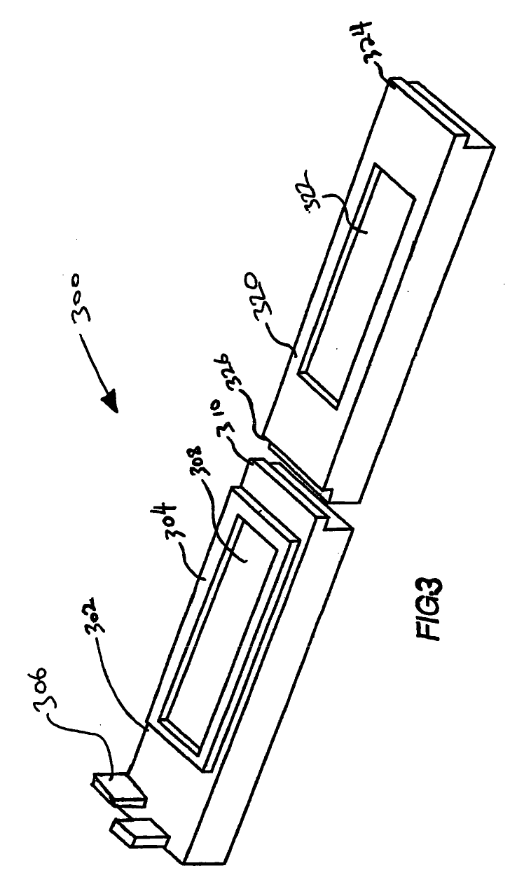

FIG. 3 illustrates a servicing module 300 having a cap/wiper component 302 and a spittoon module 320 according to a further embodiment of the invention. The servicing module 300 varies from the servicing module 80 illustrated in FIG. 1, in that the cap component and the wiper component are combined as a single cap/wiper component 302. As is shown in FIG. 3, the cap/wiper component 302 includes a cap member 304 and a plurality of wiper members 306. Although the servicing module 300 is illustrated with a dual wiper assembly, it should be understood that in other embodiments of the invention, any reasonably suitable number of wiper members 306 may be employed. The wiper members 306 may be constructed with rounded exterior wiping edges, and an angular interior wiping edge, as described in the HEWLETT PACKARD COMPANY's U.S. Pat. No. 5,614,930. In addition, each of the wiper members 306 may be constructed of a flexible, resilient, non-abrasive, elastomeric material, such as nitrile rubber, ethylene polypropylene diene monomer (EPDM), or other comparable materials.

The cap component 304 generally operates to seal a printhead. The cap member 304 may include an upper surface which may define a series of channels or troughs, to act as a vent path to prevent depriming of the printheads upon sealing. A description of such an arrangement is to be found in U.S. Pat. No. 5,867,184, currently assigned to the present assignee, the HEWLETT-PACKARD COMPANY. The cap member 304 may be constructed of a flexible, resilient, non-abrasive, elastomeric material, such as nitrile rubber, ethylene polypropylene diene monomer (EPDM), or other comparable materials. Located generally beneath the cap member 304 is a cavity 308 configured to collect ink that may be expelled from the printheads during and after a capping operation. Although not specifically illustrated, an ink absorber may be situated within the cavity 308. The ink absorber may be comprised of a foam material, although a variety of other absorbing materials may also be used.

The spittoon component 320 includes an opening 322 configured to receive spitted ink. Although not illustrated, the opening 322 generally leads to a spittoon chamber which generally operates to store the spitted ink. The spittoon chamber may have a volume that is smaller than conventional spittoons, having a capacity of, for example, approximately 40 ml. By providing an individually replaceable spittoon, its volume may be selected such that it is easier to handle (particularly when full) and thus dispose of than a conventional larger spittoon which is arranged to last the entire working life of an integrated servicing module. Thus, in such an embodiment, the cap/wiper component may be designed to last substantially longer than the design life of the spittoon. Additionally, such an individually replaceable spittoon may take up less space in the printer. This may provide advantages in the design of printers. For example, in some printers, the spittoon size may contribute directly to the size of the footprint of the printer. Thus, by providing smaller spittoons, the size of the printer may be reduced.

The internal volume of the spittoon may be an empty space, or may contain an ink absorbing substance, as is well known in the art. The ink absorbing substance may be composed of a foam material, although a variety of other absorbing materials may be used. Alternative ink absorbing materials include porous materials, for instance, an open-cell thermoset plastic such as a polyurethane foam, a sintered polyethylene, or other functionally similar materials. The ink absorber may include inkjet ink solvent which may comprise a hygroscopic material that absorbs water out of the air. Suitable hygroscopic solvent materials include polyethylene glycol (“PEG”), lipponic-ethylene glycol (“LEG”), diethylene glycol (“DEG”), glycerin or other materials having similar properties. These hygroscopic materials are liquid or gelatinous compounds that will not readily dry out during extended periods of time because they have an almost zero vapor pressure.

The spittoon component 320 includes a handle 324 for facilitating the insertion and removal thereof with respect to the service station carriage 90. In a like manner, the cap/wiper component 302 also includes a handle 310. The spittoon component 320 further includes a notch portion 326 located generally opposite the handle 310. The notch portion 326 is generally sized and positioned to enable the handle 310 of the cap/wiper component to be positioned adjacent thereto without substantial interference. In addition, when the spittoon component 320 and the cap/wiper component 302 are positioned within a bay of the service station carriage 90, the handle 310 of the cap/wiper component 302 and the notch portion 326 are designed to enable either the spittoon component 320 or the cap/wiper component 302 to be removed from the bay without causing substantial disturbance of the other component. By way of example, the spittoon component 320 may be removed from the bay without requiring that the cap/wiper component 302 also be removed from the bay.

In an alternative embodiment, the spittoon component 320 and the cap/wiper component 302 may be configured without respective handles 324 and 310. It should therefore be understood that the spittoon component 320 and the cap/wiper component 302 may be installed and removed from the bay without requiring the use of the handles 324 and 310. In addition, the spittoon component 320 may be configured without the notch portion 326.

It should be understood that embodiments of the invention other than those described hereinabove are contemplated within the scope of the present disclosure. For example, a spittoon component and a cap component may be formed as an integral unit, without a wiper component. Thus, a servicing module may be made up of a combined spittoon and cap component and a separate wiper component. Alternatively, a servicing module may be made up of a combined spittoon and wiper component and a separate cap component. It should therefore be understood that any desired combination of servicing components which form a separately replaceable subset of the set of components of a servicing module are contemplated within the scope of the invention. It should also be understood that such a combination may also contain less servicing components that the three (cap, wiper and spittoon) components described in the above embodiments. Furthermore, alternative or further types of servicing components over and above the three (cap, wiper and spittoon) components described in the above embodiments are contemplated within the scope of the invention. Indeed, it should also be understood that single, separately replaceable servicing components, designed for use as part of a servicing module are contemplated within the scope of the invention. For example, a component containing a spittoon only; or a component containing a cap only; or a component containing a wiper only.

According to one embodiment of the invention, one or more of the components of a servicing module may be separately replaceable without substantially disturbing any of the other components. In this regard, each of the servicing modules may be composed of two or more components which are separately replaceable. Therefore, according to this embodiment of the invention, for example, the spittoon component may be replaced without replacing, for example, a cap component, or a wiper component, or a combined cap/wiper component. In addition, during the replacement operation, the spittoon component may be removed and a new spittoon module installed without substantially disturbing the other component or components. Alternatively, some or all of the components may be removed from the service station bay during replacement of one or more of the components.

In accordance with another embodiment of the invention, a kit for servicing printers may contain one or more hardcopy items and one or more servicing components of a servicing module. Examples of suitable hardcopy items include printheads, ink supply apparatus (for example, an ink reservoir, a print cartridge or an ink supply tube), and apparatus for forming images on print media. By way of example, a kit may contain a printhead and a spittoon component of a servicing module, or a printhead and a cap component of a servicing module, or an ink supply and a spittoon component of a servicing module, or any other desired combination of hardcopy items and components of servicing modules. In this manner, a kit may contain a new hardcopy item such as a printhead together with selected servicing components to service that hardcopy item. The selected servicing components may include those that are deemed to be desirable to replace when replacing the hardcopy item. However, the selected servicing components may exclude those that are not necessary to replace when replacing the hardcopy item. In one embodiment, the selected servicing components may be colour coded with the same colour as the hardcopy item. This may reflect the ink colour with which the hardcopy item is associated. So, a magenta printhead and its associated cap, which may for example form a kit, may both be marked with a magenta colour code. Furthermore, both hardcopy items and the servicing components may be physically shaped so as to be usable only with a given ink colour. This technique is sometimes referred to as using “mechanical lockouts”. Thus, using mechanical lockouts, servicing components may be made suitable for use with hard copy items of one ink colour only. In this manner servicing components provided in a kit may be made suitable for use with one or more hard copy items also supplied in the kit.

In addition, the kit may contain a combination of components of servicing modules without any hardcopy items. For instance, the kit may contain a cap component and either a wiper component or a spittoon component of a servicing module. In either case, these combinations may be supplied as separate components or as an integrated component. Alternatively, the kit may contain a wiper component and either a spittoon component or a further component. Again, such a combination may be supplied as separate components or as an integrated component.

A further embodiment of the invention includes a kit for servicing printers that includes a single servicing component, which serves a single servicing function, again without any hardcopy items. For example, a single spittoon component; or a single cap component; or a single wiper component; or any other desired servicing component.

By virtue of the embodiments of the invention, the cost associated with performing printing operations may be reduced in comparison to known servicing mechanisms and methods. Alternatively, it may be viewed as providing improved servicing operations for a given cost. As an example, individual servicing components may be separately replaced according to individual wear and/or damage.

While the invention has been described with reference to certain embodiments thereof, those skilled in the art may make various modifications to the described embodiments of the invention without departing from the true spirit and scope of the invention.

For example, whilst the above-described embodiments have been described in the context of inkjet printers, it will be apparent to the skilled reader that the present invention may be applied with benefit to non-inkjet printing systems where multiple servicing tasks are implemented with respect to a printhead.

Additionally, whilst the servicing modules of the above-described embodiments were described as comprising two or three separate units, with each comprising one or two servicing components, it will be apparent to the skilled reader that this could be varied in other embodiments of the invention. For example, a given servicing module according to other embodiments of the invention could comprise four or more separately replaceable units. Furthermore, each unit could comprise any desired number of servicing components; such as one, two, three, or more.

The terms and descriptions used herein are set forth by way of illustration only and not meant as limitations. In particular, although the present invention has been described by examples, a variety of devices would practice the inventive concepts described herein. Although the invention has been described and disclosed in various terms and certain embodiments, the scope of the invention is not intended to be, nor should it be deemed to be, limited thereby and such other modifications or embodiments as may be suggested by the teachings herein are particularly reserved, especially as they fall within the breadth and scope of the claims here appended. Those skilled in the art will recognize that these and other variations are possible within the spirit and scope of the invention as defined in the following claims and their equivalents.

What is claimed:

1. An inkjet printing device comprising a plurality of printheads and a plurality of servicing modules, each module comprising first and second sets of servicing components and being arranged to service exclusively a given printhead, said first set comprising a spittoon and said first or said second set being independently replaceable.

2. A printing device according to claim 1, wherein said independently replaceable set of servicing components comprises a single type of servicing component, such as a spittoon or cap or wiper.

3. A printing device according to claim 1, wherein said independently replaceable set of servicing components comprises two or more types of servicing component.

4. A printing device according to claim 3, wherein said independently replaceable set of servicing components is formed as an integral unit.

5. A printing device according to claim 3, wherein said independently replaceable set of servicing components is formed as a plurality of separate units.

6. A printing device according to claim 3, wherein said independently replaceable set of servicing components comprises;
(a) a wiper component and a cap component; or,
(b) a cap component and a spittoon component; or,
(c) a spittoon component and a wiper component; or,
(d) any one of a wiper component, or a cap component, or a spittoon component and a further servicing component.

7. A printing device according to claim 1, wherein each of the first and second sets of servicing components are independently replaceable.

8. A printing device according to claim 7, wherein each of the first and second sets of servicing components comprise at least one servicing component from the list of: a wiper component; a cap component; or, a spittoon component.

9. A printing device according to claim 1, further comprising at least a third set of servicing components.

10. A printing device according to claim 1, wherein said device further comprises a service station bay configured to mount said plurality of servicing modules, such that each of said plurality of servicing modules may be selectively removed.

11. An inkjet printing device comprising a removable servicing module arranged to service exclusively a given printhead, the module comprising a spittoon and one or more further servicing components, the spittoon being separately replaceable.

12. A printing device comprising one or more removable servicing modules, each arranged to service exclusively a respective printhead, each of said one or more servicing modules comprising a plurality of servicing components, wherein a subset of said plurality of servicing components for each servicing module is separately replaceable.

13. A method of servicing an inkjet printing device comprising a printhead and a servicing module arranged to service exclusively said printhead and comprising a first set of servicing components comprising a spittoon and a second set of servicing components, the method comprising the step of:
replacing one but not the other of said first and second sets of servicing components.

14. A method according to claim 13, wherein said replacing step may be carried out substantially without disturbing the set of servicing components which is not replaced.

15. A method according to claim 13, wherein said replacing step further comprises the step of replacing at least one hardcopy item such as a printhead, or an ink supply apparatus.

16. A kit for servicing an inkjet printer, said kit comprising: at least one hardcopy component; and at least one, but less then all, of the following servicing components: a wiper, a cap and a spittoon.

17. A kit according to claim 16, wherein said at least one hardcopy component comprises a printhead or an ink cartridge and each of said at least one servicing components is suitable for servicing said printhead or ink cartridge.

18. A kit for servicing an inkjet printer, said kit comprising: at least one hardcopy component such as a printhead, or an ink supply apparatus; and at least one servicing component, such as a wiper, a cap or a spittoon, suitable for use in a servicing module as defined in claim 1.

19. A kit for servicing an inkjet printer, said printer comprising a printhead and being arranged to support a removable servicing module adapted to service said printhead exclusively, said module comprising first and second sets of servicing components, wherein said first set is separately replaceable, said kit comprising one or more servicing components corresponding to said first set.

20. A kit according to claim 19, comprising a spittoon component, or a wiper component, or a cap component.
